(19) United States
(12) Patent Application Publication
(10) Pub. No.: US 2023/0066424 A1
(43) Pub. Date: Mar. 2, 2023

(54) Demand-Side Platform Supporting Digital Asset Provisioning

(71) Applicant: Permission.io Inc., La Jolla, CA (US)

(72) Inventor: Charles H. SILVER, La Jolla, CA (US)

(21) Appl. No.: 17/895,447

(22) Filed: Aug. 25, 2022

Related U.S. Application Data
(60) Provisional application No. 63/237,465, filed on Aug. 26, 2021.

(51) Int. Cl. G06Q 30/02

(52) U.S. Cl. CPC G06Q 30/0273; G06Q 30/0269

(57) ABSTRACT

Systems, methods, devices, and non-transitory media of the various embodiments may include a demand-side platform (DSP) supporting digital asset provisioning. Various embodiments may provide DSP enabled methods for rewarding end users for engaging with and/or supplying data to advertisers. Various embodiments may provide a DSP that supports methods for rewarding end users with digital assets for engaging with and/or supplying data to advertisers. Various embodiments may enable advertisers to structure advertising campaigns and allocate digital assets for rewards for user engagement with advertisements in the advertising campaign via a DSP. Various embodiments may enable advertisers to verify that user interactions, such as clicks, downloads, views, etc., were actually performed by a human user.

### RELATED APPLICATIONS

This application claims the benefit of priority to U.S. Provisional Application No. 63/237,465 entitled “Demand-Side Platform Supporting Digital Currency Provisioning” filed Aug. 26, 2021, the entire contents of which are hereby incorporated by reference for all purposes.

### SUMMARY

Systems, methods, devices, and non-transitory media of the various embodiments may include a demand-side platform (DSP) supporting digital asset provisioning. Various embodiments may provide DSP enabled methods for rewarding end users for engaging with and/or supplying data to advertisers. Various embodiments may provide a DSP that supports methods for rewarding end users with digital asset(s) for engaging with and/or supplying data to advertisers. Various embodiments may enable advertisers to structure advertising campaigns and allocate digital asset(s) for rewards for user engagement with advertisements in the advertising campaign via a DSP. Various embodiments may enable advertisers to verify that user interactions, such as clicks, downloads, views, etc., were actually performed by a human user.

Various aspects may include enabling an advertiser to attach a digital asset offering to an advertisement via a demand-side platform (DSP); offering the advertisement to a user including an indication of the offered digital asset; determining that the user interacted with the advertisement; and in response to determining that the user interacted with the advertisement: providing the offered digital asset to the user; and providing user data to the advertiser, wherein the user data includes a verifiable attribute associated with one or both of the user and the provided offered digital asset. Some aspects may further include providing feedback to the advertiser via the DSP regarding providing of offered digital assets to the user. In some aspects, the digital assets may be cryptocurrency, non-fungible tokens, semi-fungible tokens, or non-fungible tokens. In some aspects, the user data may be data the user provided explicit permission to collect. In some aspects, the user data may be zero-party data. In some aspects, the user interaction may be one or more of a click, a video playout, and a data input. Various aspects may include determining an amount of additional digital assets for the user that are associated with historical reengagement by the user in response to determining that the user interacted with the advertisement; and providing an indication of the amount of additional digital assets to the advertiser.

Various aspects include a device including a processor configured with processor-executable instructions to perform operations of any of the methods summarized above. Various aspects also include a non-transitory processor-readable medium on which is stored processor-executable instructions configured to cause a processor of a device to perform operations of any of the methods summarized above. Various aspects include a system comprising one or more devices configured to perform operations of any of the methods summarized above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a system block diagram of an example system including a demand-side platform (DSP) in accordance with various embodiments.

FIG. 2A is a call flow diagram of an example digital asset associated campaign offering via DSP in accordance with various embodiments.

FIG. 2B illustrates an example of interactions in accordance with various embodiments to provide permissioned data to advertisers.

FIG. 3A is a process flow diagram illustrating a method for rewarding end users for engaging with and/or supplying data to advertisers in accordance with various embodiments.

FIG. 3B is a process flow diagram illustrating another method for rewarding end users for engaging with and/or supplying data to advertisers in accordance with various embodiments.

FIG. 4 is a component block diagram of a server that is a computing device suitable for use in the various embodiments.

FIG. 5 is a component block diagram of a laptop that is a computing device suitable for use in the various embodiments.

FIG. 6 is a component block diagram of a smartphone that is a computing device suitable for use in the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The term “computing device” as used herein refers to any one or all of cellular telephones, smartphones, personal or mobile multi-media players, personal data assistants (PDA's), laptop computers, personal computers, servers, tablet computers, smartbooks, ultrabooks, palm-top computers, multimedia Internet enabled cellular telephones, and similar electronic devices that include a memory and a programmable processor. While specific examples are listed above, the various embodiments are generally useful in any electronic device that includes a processor and executes application programs.

As used herein, the term “digital asset” refers to any digitally stored, exchanged, and/or managed asset or token. Examples of such digital assets include cryptocurrencies, cryptographic tokens, virtual currencies, digital money, fungible tokens (FTs), non-fungible tokens (NFTs), semi-fungible tokens (SFTs), etc. One specific example of a digital asset may be Permission.io's ASK cryptocurrency. Permission.io's ASK cryptocurrency is a tokenized reward for advertisement technology and opt-in data exchange. ASK enables individuals to control, “permission” and be rewarded for their data in multiple advertising contexts. This allows advertisers to offer rewards for permissioned data and engagements, driving growth and building loyalty in a compliant way. ASK is cryptocurrency for the consumer, and as such has the advantages of both a digital asset and a superior consumer loyalty reward in that ASK is liquid, global, and versatile. Permission.io seeks to help individuals all over the globe earn from their time and data, as well as help advertisers build trust, improve engagement and increase return on investment. Permission.io is the leading provider of permission advertising. Government regulation, declining return on investment, and individual awareness has led to an inexorable movement where advertisers will need to obtain explicit consent to use personal data. Permission.io has created the cryptocurrency ASK to serve as the digital reward for advertisers to obtain that consent and an advertising platform where it can be utilized at scale to engage with audiences like never before. Using ASK, advertisers drive sales by forming a direct, trusted relationship with consumers and rewarding them for their engagement. Permission.io's mission is to have ASK be the most widely used reward throughout the ad-tech ecosystem for advertisers to obtain permission and motivate action. Other specific examples of digital assets may include Bitcoin, Ethereum, and/or a NFT (e.g., a collectible NFT such as a Bored Ape NFT or an advertiser-branded NFT such as an Anheuser Busch NFT).

As user herein, the term “zero-party data” refers to personal information that is collected from a user who has opted to proactively share their data with an advertiser (or marketer).

Various embodiments may provide a demand-side platform (DSP) that enables users to be provided digital assets for interacting with advertising (or ads) and granting permission for user data, such as zero-party data, to be captured and sent to an advertiser. Various embodiments may provide a DSP that enables advertisers to customize provisioning of digital assets to users in exchange for advertising interaction and permissioned user data, such as zero-party data.

Various embodiments may provide a DSP that facilitates a permissioned, compliant method for advertisers to reward consumers with digital assets for engaging with advertiser's brands and supplying the advertisers with zero-party data. A DSP may be a technology platform that enables advertising buyers to access advertising exchanges and, by doing so, participate in a real-time bidding process for publisher advertising inventory.

In various embodiments, a DSP may enable advertisers to, in addition to the cost of media placement itself, be given the opportunity to attach a digital asset offering to each ad. In some embodiments, there may be no cost of media placement. Rather, the spend on the cost of the media placement itself may be in digital assets as well. In various embodiments, when a consumer sees the ad, the consumer may also see the amount of digital assets they can earn by engaging with the ad. As examples, engagement may include clicking on the ad, watching a video playout of the ad, and/or providing data. In various embodiments, after engagement, such as after clicking on the ad, the consumer may be driven to the landing page of the advertiser's choice and/or the advertiser's website. After being taken to the landing page and/or the advertiser's website, the consumer may be given the opportunity to claim the digital assets the user earned by setting up an account and/or if that consumer already has an account, then digital assets may be automatically deposited into the consumer's digital asset wallet. The digital asset transactions may be held pending for a short period of time to ensure validity of the transaction, and the consumer may then be free to withdraw their digital assets when the amount of digital assets reaches a minimum threshold. In various embodiments, a DSP may provide know your customer (KYC) services to comply with regulations and compliance requirements, as well as to limit fraud in digital asset transactions.

In various embodiments, DSP clients may use digital assets to reward users and provide a means to ensure that the end users receive and understand their reward, With digital assets, users can be incentivized to engage and provide data to brands that otherwise could not be obtained. In various embodiments, a DSP may allocate digital assets. In various embodiments, the digital assets may be digital assets associated with the DSP, digital assets associated with the advertiser advertiser-branded tokens or NFTs), digital assets associated with various blockchains (e.g., ASK, Bitcoin, etc.), combinations of different digital assets, or any other type of digital assets. In various embodiments, a DSP may enable an advertiser to select interactions requested of a user, such as a user clicking a link in an advertisement, a user playing out an advertisement, a user inputting requested data, etc., and a DSP may enable an advertiser to select a payout of digital assets to the user in response to the selected interaction. In various embodiments, a DSP may enable an advertiser to select a type, or combinations of more than one types, of digital assets to be paid out to the user in response to a selected interaction (e.g., different digital assets for different interactions, different digital assets based on a user's selection from two or more available digital assets, etc.). In various embodiments, a DSP may enable an advertiser to traffic one or more campaigns to users, such as by setting campaign budgets, setting campaign start dates, setting campaign end dates, etc. In various embodiments, a DSP may enable an advertiser to upload advertising campaign creative materials, such as advertising media, to be output to users. In various embodiments, a DSP may enable administration of margin and pricing rules related to digital asset inclusion.

In various embodiments, a DSP may enable advertisers to create a campaign and associate that campaign with digital assets to be provided to users. A campaign may be an e-commerce related delivery to users, such as an advertising campaign, in which branded content from the advertiser is provided to the user (e.g., as video advertisements, static ads, etc.). A campaign may run for a period of time, such as days, weeks, months, etc. The campaign may include a campaign spend which may be a total amount of fiat currency (e.g., government backed money) to use to buy ad space to provide the branded content of the campaign to users over the Internet. An advertiser may provide their branded content (e.g., video ads, static ads, etc.) to a DSP in various embodiments, and may allocate a budget of digital assets to be offered (e.g., an amount offered). This allocated budget of digital assets may be tied to an amount of fiat currency (e.g., government backed money) the advertiser provides for the purpose of allocating digital assets. The allocation of fiat currency (e.g., government backed money) required for the allocated budget of digital assets may be tied to the campaign spend, such as at a set percentage (e.g., 15%), though the amount (e.g., the set percentage) may be adjusted by DSP settings and/or user preferences. As users interact with the branded content of the campaign, the users may be provided digital assets. The amount of digital assets actually allocated to users based on their interaction with the campaign may be the amount claimed and represent the amount of digital assets actually allocated during the campaign. The allocated budget of digital assets will exceed or be equal to the amount claimed.

In various embodiments, a DSP may enable an advertiser (e.g., a DSP user, such as an ad buyer using the DSP) to toggle reward action type (e.g., clicks, play, providing data) and payout for an action. In various embodiments, a DSP may provide a daily cap and global cap on rewards offered as well as visualization of historical reward action types and their performance. In various embodiments, a DSP may provide a reward frequently asked questions section to guide DSP users in selecting the right reward amount and type for a campaign.

In various embodiments, a DSP may enable an advertiser (e.g., a DSP user, such as an ad buyer using the DSP) to traffic one or more campaigns by setting a campaign budget, a start date and an end date.

In various embodiments, a DSP may enable an advertiser (e.g., a DSP user, such as an ad buyer using the DSP) upload their content (e.g., brand creative, brand content, ad content, etc.) to provide to users and select the treatment type for digital asset enabled campaigns. Treatments may include simple served ads or videos, and/or dynamic creative content (DCO) type approaches where data can be collected securely and seamlessly within the uploaded content (e.g., the creative for brand, brand content, ad content, etc.). In various embodiments, a DSP may allow for a preview of the enabled content (e.g., brand creative, brand content, ad content, etc.). In various embodiments, a DSP may provide backend features to connect or redirect identifiers (IDs) for reporting purposes. For campaigns that require a data capture component, in various embodiments, a DSP may allow for one or both of a hosted (e.g., a DSP hosted collection form) and a non-hosted (e.g., an advertiser customer data platform (CDP) hosted form). For hosted, a DSP may provide a template that can be augmented based on the desired fields along with branding and the rewards integration. For non-hosted, a DSP may utilize the native CDP tags to add to the advertiser form for capture, if desired by the advertiser.

In various embodiments, a DSP may enable global administration of margin and pricing rules related to digital asset inclusion.

In various embodiments, an advertiser may interact with a user interface of a DSP to generate a campaign to provide one or more ads to users. The advertiser may enter a digital asset allocation and media budget for the campaign via the user interface of the DSP. The DSP may interact with an opt-in e-commerce digital asset platform, such as Permission.io's platform and an associated blockchain, such as the Polygon blockchain, Permission blockchain, Ethereum blockchain, etc., to generate rewarded ads for the campaign that are served to a target audience. The ability to receive digital assets for interacting with the rewarded ads incentivizes the target audience to take an action in relation to the rewarded ads, such as playing the ad videos, clicking on the ads, providing requested data, etc. In response to the user action occurring, the user's data may be captured and sent to the advertiser, such as to the advertiser's CDP. The advertiser may retain the permissioned zero-party data. In response to the user action occurring, the user may be rewarded with digital assets, such as ASK tokens, Bitcoin, advertiser-branded digital assets, etc., and the user's digital wallet may be updated to reflect the increased awarded digital assets. The user may spend the digital assets, exchange the digital assets, or hold (e.g., HODL) the digital assets. Feedback on the digital asset allocation may be provided to the advertiser to enable the advertiser to track allocation and potentially retarget future campaigns.

In various embodiments, a DSP may enable advertisers to verify that user interactions, such as clicks, downloads, views, etc., were actually performed by a human user. Digital fraud in relation to digital advertising, such as the use of bots (i.e., automated or semi-automated software agents or other type of programs) to engage in click fraud, may be a significant challenge in digital advertising as advertising revenue may be spent for engagement that did not actually occur. Various embodiments may provide verifiable attributes to an advertiser that verify a user actually interacted with an advertisement. As the transaction to provide a digital asset may be recorded in a blockchain in various embodiments, the issuance of the digital assets via the blockchain may serve as a verification mechanism for advertisers that the interaction with the advertisement was by a human. For example, before a user is able to transfer earnings for a particular interaction to an active wallet (i.e., before the user may be provisioned a digital asset), the user must undergo a two-part identity verification process. When a user completes identity verification, the advertiser is assured that the interaction with the advertisement that resulted in the provisioning of the offered digital assets was by a human and not an interaction performed by a bot. In various embodiments, user data provided to an advertiser by a DSP may include a verifiable attribute associated with one or both of the user that interacted with the advertisement and the provided offered digital asset. For example, data identifying the user specifically, and/or the user's wallet, may be provided by the DSP to the advertiser. As another example, a pointer or other identifier that may enable the transaction to provide the digital assets to be referenced in a blockchain may be provided by the DSP to the advertiser.

In various embodiments, a DSP may support reengagement of users by advertisers by providing indications of an estimated amount of digital assets that may be likely to cause the user to reengage, or further engage, with an advertisement. For example, based on historical engagement data for a user, the DSP may estimate a likely amount of digital assets that would incentivize the user to reengage (e.g., rewatch a video, return to a website, etc.) or further engage (e.g., watch a longer portion of a video, remain on a website, etc.). In various embodiments, the DSP may provide an indication of such an estimated reengagement amount of digital assets to an advertiser after a user engages with the advertiser's initial advertisement. In this manner, the advertiser may identify a specific amount of digital assets for that user that may support reengagement, and the advertiser may direct the DSP to offer such additional digital assets to the user for the reengagement.

In various embodiments, a DSP may provide wallet hub services for different wallet interactions. A DSP may interact with different wallet systems used by different users and/or a DSP may provide wallet services. In various embodiments, a DSP may track data associated with wallets of users, such as historical data about wallet usage, data reflecting transactions of digital assets into and out of user wallets, etc. In various embodiments, the DSP may operate as an open wallet architecture enabling different digital assets to be provided to user wallets.

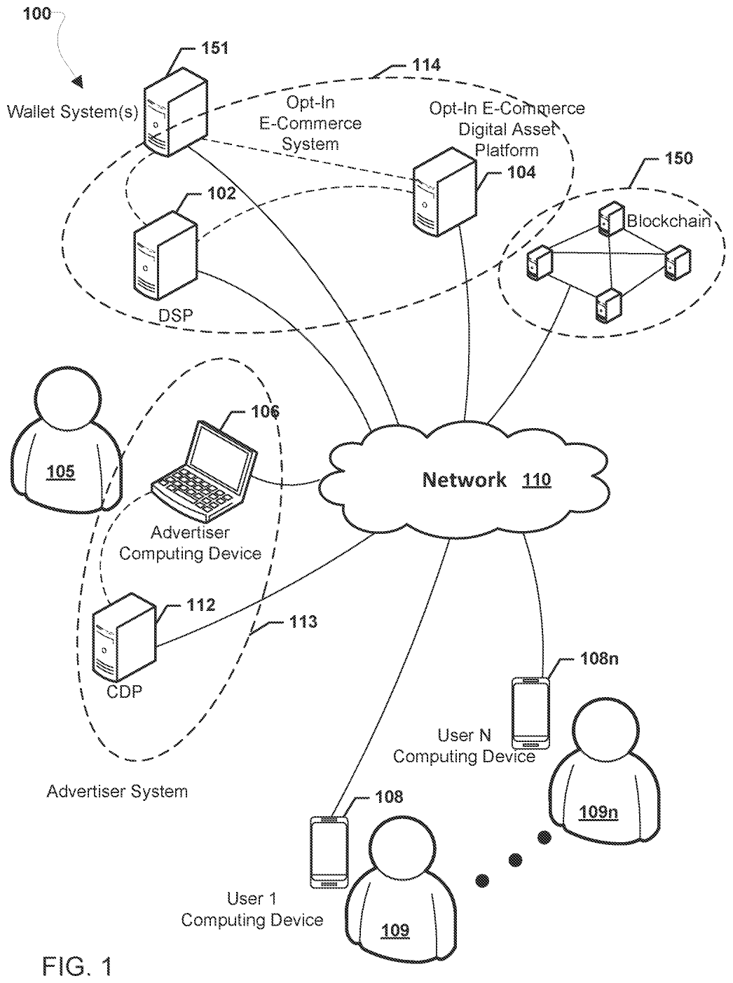

FIG. 1 illustrates an example system 100 including a demand-side platform (DSP) 102 in accordance with various embodiments. The system 100 may include a DSP 102, an opt-in e-commerce digital asset platform 104, an advertiser computing device 106, a customer data platform (CDP) 112, a blockchain 150, one or more wallet systems 151, and/or one or more user computing devices 109-109n. The DSP 102, the opt-in e-commerce digital asset platform 104, the advertiser computing device 106, the CDP 112, the blockchain 150, the wallet systems 151, and/or the one or more user computing devices 109-109n may be connected to one or more networks 110, such as the Internet, and may exchange one another via their various connections to the network 110. In various embodiments, the DSP 102 and opt-in e-commerce digital asset platform 104 may interface directly with one another. In various embodiments, the advertiser computing device 106 and CDP 112 may interface directly with one another. The communications between the DSP 102, the opt-in e-commerce digital asset platform 104, the advertiser computing device 106, the CDP 112, the wallet systems 151, the blockchain 150, and/or the one or more user computing devices 109-109n may be secure communications using end-to-end encryption.

While FIG. 1 illustrates the DSP 102 and opt-in e-commerce digital asset platform 104 as singular devices, the illustration as a singular device is merely for ease of illustration and the DSP 102 and/or opt-in e-commerce digital asset platform 104 may include multiple interconnected computing devices operating together to perform the operations discussed herein in relation to the DSP 102 and/or opt-in e-commerce digital asset platform 104. While FIG. 1 illustrates the CDP 112 as a single device, the illustration as a singular device is merely for ease of illustration and the CDP 112 may include multiple interconnected computing devices operating together to perform the operations discussed herein in relation to the CDP 112. Additionally, while FIG. 1 only illustrates a single advertiser 105, advertiser computing device 106, and CDP 112, multiple advertisers, advertiser computing devices, and CDPs may be present in the system 100 and interact with the DSP 102 in various embodiments. Further, while FIG. 1 only illustrates a single blockchain 150 and wallet systems 151, multiple blockchains and wallet systems may interact with the DSP 102 in various embodiments.

In various embodiments, an advertiser 105 (also referred to as a platform user or DSP user) may utilize their advertiser computing device 106 to interact with the DSP 102. In some implementations the advertiser 105 may use their advertiser computing device 106 to interact with the CDP 112. In some implementations the advertiser computing device 106 and CDP 112 may be components of an advertiser system 113.

The DSP 102 may interact with the opt-in e-commerce digital asset platform 104 to provide advertisements and digital asset rewards to the user computing devices 108-108n and, thereby, the users 109-109n using those user computing devices 108-108n. In some implementations the DSP 102 and opt-in e-commerce digital asset platform 104 may be components of an overall opt-in e-commerce system 114. Additionally, a blockchain 150 may be part of the overall opt-in e-commerce system 114 and/or may be accessible to the overall opt-in e-commerce system. The blockchain 150 may be a distributed ledger system formed from decentralized nodes. For example, the blockchain 150 may be any type of blockchain, such as the Polygon blockchain, Permission blockchain, Ethereum blockchain, etc. The nodes of the blockchain 150 may be connected to the network 110. The DSP 102 may interact with the blockchain 150 via connections to the network 110. The opt-in e-commerce digital asset platform 104 may interact with the blockchain 150 via connections to the network 110. Additionally, the overall opt-in e-commerce system 114 may include one or more wallet systems 151. The wallet systems 151 may enable wallet applications and application programming interfaces (APIs) of user computing devices 108-108n to send and/or receive digital assets and may provide authentication services for users 109-109n. While illustrated as separate systems in FIG. 1, in some configurations the DSP 102 may be configured to perform operations and provide functionality described herein with reference to the opt-in e-commerce digital asset platform 104 and/or the wallet systems 151.

As a specific, but non-limiting, example, the opt-in e-commerce digital asset platform 104 may be Permission.io's e-commerce system including an associated blockchain 150, such as the Polygon blockchain, Permission blockchain, Ethereum blockchain, etc. In various embodiments, the opt-in e-commerce digital asset platform 104 may be a platform that enables users 109-109n to control how their user data is gathered and/or provided for advertisers, such as advertiser 105, and to be rewarded for providing their user data, such as zero-party data, to advertisers, such as advertiser 105. In various embodiments, the opt-in e-commerce digital asset platform 104 may provide a digital wallet to users 109-109n to enable the storage and tracking of digital assets owned by the users 109-109n and/or may interface with the wallet systems 151 to provide a digital wallet to users 109-109n to enable the storage and tracking of digital assets owned by the users 109-109n. In various embodiments, the opt-in e-commerce digital asset platform 104 may provide digital asset transaction validation and signing services and/or may provide a list of transactions.

In various embodiments, the DSP 102 may provide a user interface to the advertiser computing device 106, such as via a web portal, application, etc., to enable the advertiser 105 to create, modify, and/or manage campaigns and digital assets associated with such campaigns. The user interface may enable the advertiser 105 to set an amount of fiat currency to allocate to a campaign. The user interface may enable the advertiser to budget fiat applied to a campaign, such as by allocating, changing, and/or setting daily allocation budgets, etc. The user interface may enable custom allocation of fiat currency within a campaign, such as ranging from 0% to 50% of overall campaign spend. The user interface may display allocation and/or show total budget and allocated media spend, which may be digital asset allocation subtracted from total budget. The user interface may enable the advertiser to set an expiration time for unclaimed digital assets, such as fourteen days, etc. The user interface may show the advertiser 105 in real time how many digital assets have been claimed versus unclaimed for a campaign that is live. The user interface may indicate the forecast of the predicted percentage of the digital assets allocated that may be claimed before an expiration date of the campaign. The user interface may support bidding modifications to incentivize users 109-109n to interact with a campaign. The user interface may enable digital asset reallocation within a campaign and various allocation approaches, including manual allocation and automatic even distribution across a campaign.

The DSP 102 may enable the advertiser 105 via their advertising computing device 106 to create a campaign and associate that campaign with digital assets from the DSP to be provided to users. A campaign may be an e-commerce related delivery to users 109-109n, such as an advertising campaign, in which branded content from the advertiser 105 is provided to the user 109-109n (e.g., as video advertisements, static ads, etc.). A campaign may run for a period of time, such as days, weeks, months, etc.

Via their advertiser computing device 106, the advertiser 105 may provide their branded content (e.g., video ads, static ads, etc.) to the DSP 102. Via their advertiser computing device 106, the advertiser 105 may allocate a budget of digital assets to be offered (e.g., an amount offered, types of digital assets to be offered). The user interface of the DSP 102 may support the advertiser 105 setting rewards of digital assets associated with a campaign, such as the reward level of digital assets provided per user interaction with the campaign, reward types of digital assets provided for certain interactions (e.g., branded digital assets for some actions, other types of digital assets for other actions, etc.).

The DSP 102 may enable the advertiser 105 via their advertising computing device 106 to select (e.g., toggle, choose from a drop-down menu, etc.) reward action type (e.g., clicks, play, providing data) and payout for an action. The reward action type may be an interaction required by a user 109-109n with their user computing devices 108-108n to result in the user 109-109n being credited digital assets associated with an advertisement. The DSP 102 may enable the advertiser 105 to provide additional digital asset incentives for multiple actions taken by a user (e.g., increased incentives for click to conversion or video play quintiles). For example, the additional digital asset incentives may support user 109-109n reengagement with advertisements. The DSP 102 may enable the advertiser 105 via their advertising computing device 106 to select the treatment type for digital asset enabled campaigns. Treatments may include simple served ads or videos, and/or dynamic creative content (DCO) type approaches where data can be collected securely and seamlessly within the uploaded content (e.g., the creative for brand, brand content, ad content, etc.). The DSP 102 may enable the advertiser 105 via their advertising computing device 106 to preview of the enabled content (e.g., brand creative, brand content, ad content, etc.). The DSP 102 may enable data collected from user computing devices 108-108n to be provided to the CDP 112 of the advertiser 105. The data from user computing devices 108-108n may be zero-party data that the users 109-109n authorized for (or gave permission for) collection and sharing with the advertiser 105. The DSP 102 may enable the advertiser 105 to set a cap, such as a daily and/or global cap, on the amount of digital assets for the campaign.

The DSP 102 may enable the advertiser 105 via their advertising computing device 106 to track the status of a campaign, such as by viewing the budget of the campaign, viewing the reward settings for the campaign, viewing the budget caps for the campaign, etc.

The DSP 102 may enable the advertiser 105 via their advertising computing device 106 to select how the digital asset offer is displayed with the advertisements of the advertiser 105. The DSP 102 may enable the advertiser 105 via their advertising computing device 106 to designate retargeting operations for users to re-engage with advertisements. The DSP 102 may track the historical engagement of users 109-109n and provide indications of the estimated digital asset amounts likely to result in reengagement for a user to the advertiser 105 via their advertising computing device 106.

The DSP 102 may enable the advertiser 105 via their advertising computing device 106 to receive reports related to the digital asset provisioning during a campaign, such as reports related to digital asset allocations over time periods (e.g., daily, weekly, monthly, etc.), campaign interaction levels, etc.

The DSP 102 may enable the advertiser 105 via their advertising computing device 106 to verify that user 109-109n interactions, such as clicks, downloads, views, etc., were actually performed by a human user. The DSP 102 may provide verifiable attributes to an advertiser 105 that verify a user 109-109n actually interacted with an advertisement. As the transaction to provide a digital asset may be recorded in the blockchain 150, the issuance of the digital assets via the blockchain 150 may serve as a verification mechanism for advertisers 105 that the interaction with the advertisement was by a human user 109-109n. For example, before a user 109-109n is able to transfer earnings for a particular interaction to an active wallet (i.e., before the user may be provisioned a digital asset), the user 109-109n must undergo a two-part identity verification process. When a user 109-109n completes identity verification, the advertiser 105 is assured that the interaction with the advertisement that resulted in the provisioning of the offered digital assets was by a human and not an interaction performed by a bot. User data provided to the advertiser 105 by the DSP 102 may include a verifiable attribute associated with one or both of the user 109-109n that interacted with the advertisement and the provided offered digital asset. For example, data identifying the user 109-109n specifically, and/or the user's wallet may be provided by the DSP 102 to the advertiser 105 via the advertiser's computing device 106. As another example, a pointer or other identifier that may enable the transaction to provide the digital assets to be referenced in the blockchain 150 may be provided by the DSP 102 to the advertiser 105 via the advertiser's computing device 106.

The DSP 102 may support reengagement of users 109-109n by advertisers 105 by providing indications of an estimated amount of digital assets that may be likely to cause the user 109-109n to reengage, or further engage, with an advertisement. For example, based on historical engagement data for a user, the DSP 102 may estimate a likely amount of digital assets that would incentivize the user 109-109n to reengage (e.g., rewatch a video, return to a website, etc.) or further engage (e.g., watch a longer portion of a video, remain on a website, etc.). The DSP 102 may provide an indication of such an estimated reengagement amount of digital assets to the advertiser 105 via the advertiser's computing device 106 after a user 109-109n engages with the advertiser's initial advertisement. In this manner, the advertiser 105 may identify a specific amount of digital assets for that user 109-109n that may support reengagement, and the advertiser may direct the DSP 102 to offer such additional digital assets to the user 109-109n for the reengagement.

The DSP 102 may provide wallet hub services for different wallet interactions by interacting with the different wallet systems 151. The DSP 102 may interact with different wallet systems 151 used by different users 109-109n and/or the DSP 102 may provide wallet services. The DSP 102 may track data associated with wallets of users 109-109n, such as historical data about wallet usage, data reflecting transactions of digital assets into and out of user wallets, etc. The DSP 102 may operate as an open wallet architecture enabling different digital assets to be provided to user wallets.

While illustrated as a standalone system, the DSP 102 may be a device and/or module of a larger media platform, such as a streaming service, search engine, web hosting service, social media platform, etc., providing DSP functionality as described herein to that larger media platform.

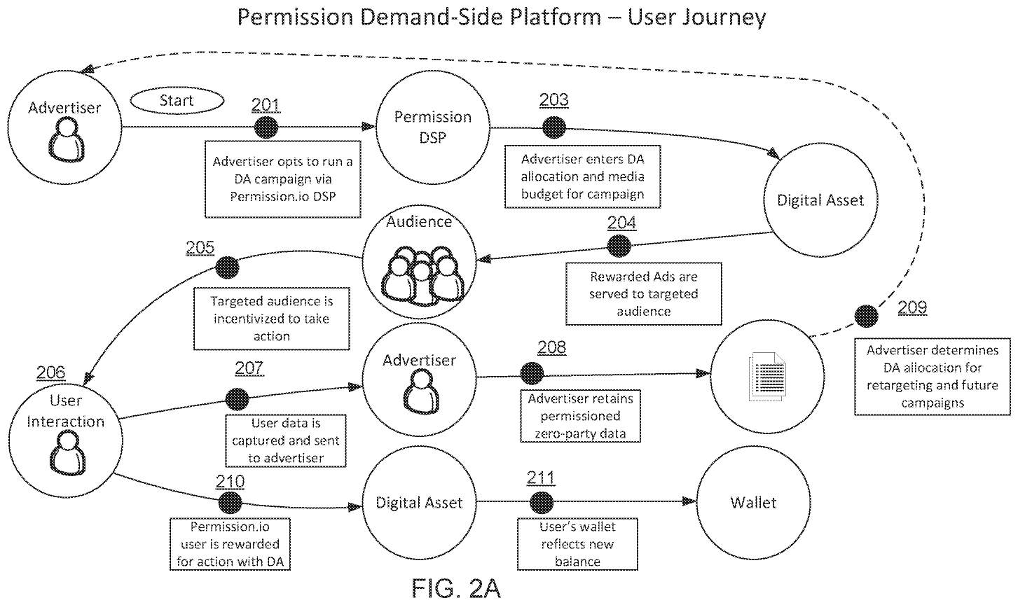

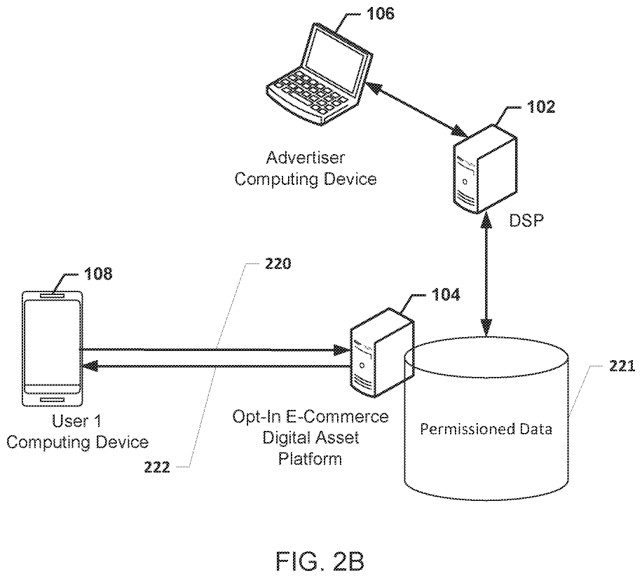

FIG. 2A is a call flow diagram of an example digital asset associated campaign offering via a DSP, such as DSP 102, in accordance with various embodiments. With reference to FIGS. 1-2A, in operation 201 the advertiser, such as advertiser 105, may opt to run a digital asset (abbreviated as “DA” in FIG. 2A) campaign via the DSP. In operation 203, the advertiser may enter the digital asset allocation and media budget for the campaign via the DSP. In operation 204, the DSP may interface with an opt-in e-commerce digital asset platform, such as opt-in e-commerce digital asset platform 104 to serve rewarded ads to a target audience, such as a target audience of users 109-109n. In operation 205, the target audience is incentivized to take an action in relation to the rewarded ads, such as by an indication with the ads of an amount of digital assets a user will receive in exchange for the action. In operation 206, a user may take an action, such as clicking on a rewarded ad. In response to the action being taken, in operation 207, the user data may be captured and sent to the advertiser, such as to the advertiser's CDP (e.g., CDP 112). In operation 208, the advertiser may retain the permissioned data. In operation 209, the advertiser may determine via the DSP digital asset allocation for retargeting and future campaigns. Additionally in response to the action being taken, in operation 210, the user is rewarded for taking the action with digital assets. In operation 211, the user's wallet is updated to reflect the new balance of digital assets.

FIG. 2B illustrates an example of interactions in accordance with various embodiments to provide permissioned data to advertisers via their advertiser computing devices 106. With reference to FIGS. 1-2B, a user computing device 108 may interact with an offered advertisement in operation 220 (e.g., click on an ad, watch a video, visit an advertiser website, etc.) while using a permissioned service, such as the Permission.io application. The interaction may be in any manner, such as via a web based application, via a mobile application, via a brand specific application, etc., and the permissioned service may track and otherwise monitor the interactions on the user computing device 108. The permissioned service may be a service in which the user has granted permission to gather data about the user and/or agreed to provide specific data via forms or other interactions (e.g., zero-party data) in exchange for digital assets. The interaction in operation 220 may cause the permissioned service to provide the user's zero-party data and/or other data, such as first party data, to the opt-in e-commerce digital asset platform 104. The opt-in e-commerce digital asset platform 104 may store the permissioned data in a permissioned data database 221. The opt-in e-commerce digital asset platform 104 may provide a digital asset allocated to the interaction to the user in operation 222. The repeated use of the permissioned service by users, such as users 109-109n may result in the permissioned data database 221 having stored therein historical permissioned data of the user. The DSP 102 may access the permissioned data database 221 and provide permissioned data to the advertiser 105 via the advertiser's computing device 106. As the historical permissioned data of the user may be permissioned data that the DSP 102 is authorized to reuse, the DSP 102 may aggregate data for one or more users and/or across one or more time periods and make such aggregated permissioned data available to advertisers 105 as audience data to power future campaigns. Additionally, the data within the permissioned data database 221 may operate as a customer data platform of permissioned data. Further, the data within the permissioned data database 221 may be used by the DSP 102 to estimate an amount of digital assets that may be likely to cause a specific user to reengage, or further engage, with an advertisement. For example, based on historical engagement data for a user in the permissioned data database 221, the DSP 102 may estimate a likely amount of digital assets that would incentivize the user to reengage (e.g., rewatch a video, return to a website, etc.) or further engage (e.g., watch a longer portion of a video, remain on a website, etc.) and provide that indication to the advertiser computing device. The DSP 102 may provide an indication of such an estimated reengagement amount of digital assets to an advertiser 105 after a user engages with the advertiser's initial advertisement.

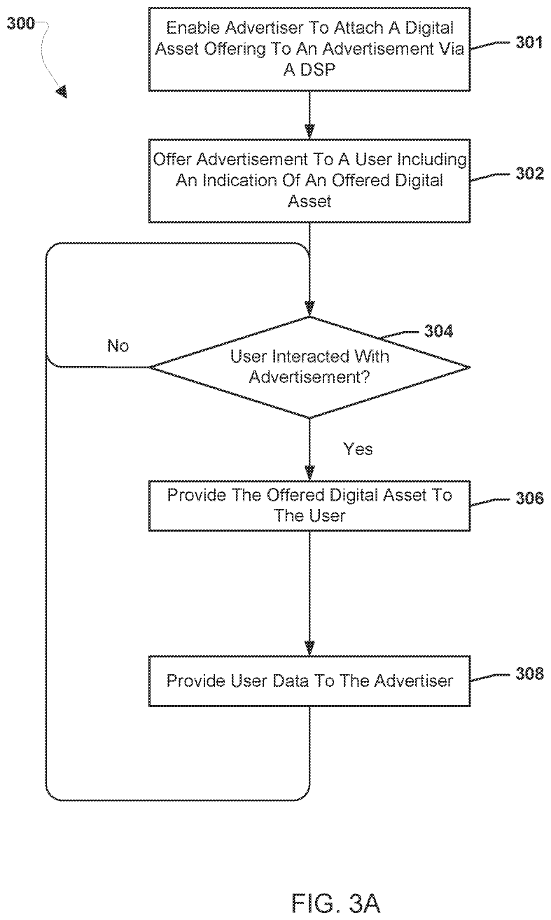

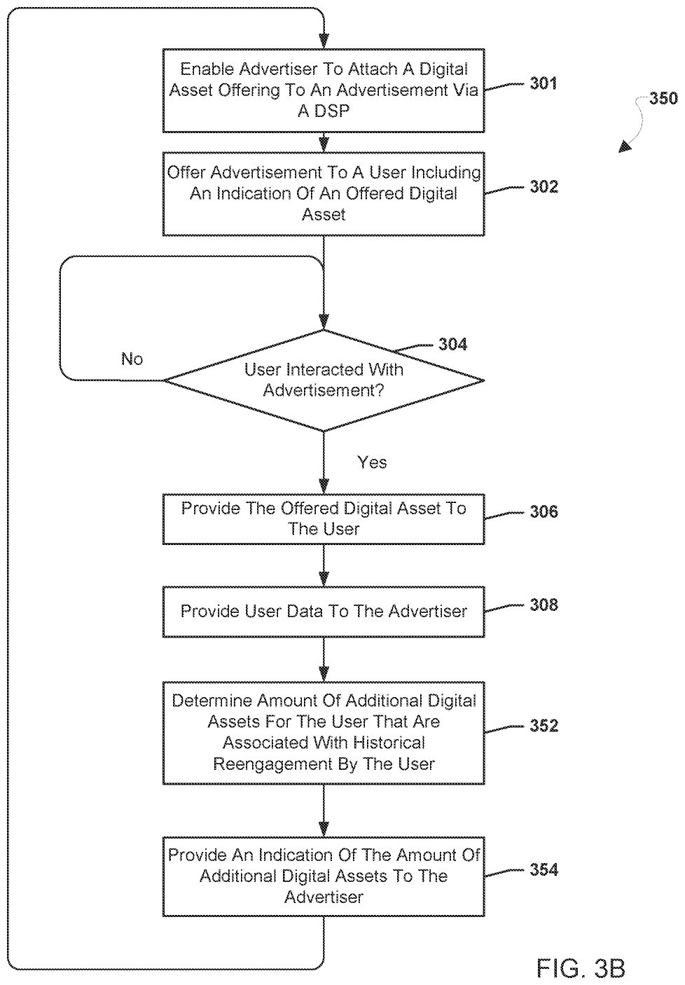

FIG. 3A is a process flow diagram illustrating a method 300 for rewarding end users for engaging with and/or supplying data to advertisers in accordance with various embodiments. With reference to FIGS. 1-3A, the operations of method 300 may be implemented by one or more devices of system 100, such as at least partially by DSP 102 and/or opt-in e-commerce digital asset platform 104.

In block 301, an advertiser may be enabled to attach a digital asset offering to an advertisement via a DSP. The DSP may be any DSP described herein, such as DSP 102. The advertiser may be enabled to attach the digital asset offering as part of setting up a campaign as described herein. Specific examples of the operations via the DSP to establish the campaign and attach a digital asset offering to an advertisement may include allocating digital assets to a campaign, setting digital asset rewards associated with a campaign, tracking campaign digital asset provisioning in a campaign, and controlling how digital assets are offered within a campaign. The digital asset attached may be a single type of digital asset or may be different types of digital assets. For example, only Bitcoin may be attached to an advertisement. As another example, Bitcoin and an advertiser branded NFT may be attached to a digital asset offering such that the user may select which digital asset they would like for taking the action.

In block 302, an advertisement may be offered to a user including an indication of an offered digital asset. The advertisement may include an indication of a required user interaction, such as a click, a video playout, a data input, etc. The advertisement may indicate the digital assets to be rewarded in response to the user taking the indicated action. The indication of digital assets to be awarded may incentivize users to take the requested action.

In determination block 304, a determination as to whether or not the user interacted with an advertisement may be made. In response to determining that the interaction did not occur (i.e., determination block 304=“No”), the method 300 may continue to determine whether or not the user interacted with an advertisement in determination block 304.

In response to determining that the user interaction occurred (i.e., determination block 304=“Yes”), offered digital assets may be provided to the user in block 306 and the user data may be provided to the advertiser in block 308. For example, digital assets may be provided to a user's wallet and a user's zero-party data may be provided to an advertiser. Additionally, other data, such as first-party data, may be provided along with the zero-party data. In this manner, digital assets may be exchanged for user interaction with advertisements. Moreover, the issuance of digital assets via a blockchain may serve as a verification mechanism for advertisers that the interaction with the advertisement was by a human. For example, before a user is able to transfer earnings for a particular interaction to an active wallet, the user must undergo a two-part identity verification process. When a user completes identity verification, the advertiser is assured that the interaction with the advertisement (e.g., the “click” on an advertisement) was by a human (and not by a bot). The user data provided to the advertiser in block 308 may include a verifiable attribute associated with one or both of the user and the provided offered digital asset. For example, data identifying the user specifically, and/or the user's wallet may be provided by the DSP to the advertiser. As another example, a pointer or other identifier that may enable the transaction to provide the digital assets to be referenced in a blockchain may be provided by the DSP to the advertiser.

The method 300 may proceed to block 304 and continue to monitor for additional user interactions in determination block 304. Additionally, advertisers may receive feedback from the DSP on the distribution of digital assets by the DSP. Further, advertisers may be enabled to adjust the digital asset offerings at various points during a campaign.

FIG. 3B is a process flow diagram illustrating a method 350 for rewarding end users for engaging with and/or supplying data to advertisers in accordance with various embodiments. With reference to FIGS. 1-3B, the operations of method 350 may be implemented by one or more devices of system 100, such as at least partially by DSP 102 and/or opt-in e-commerce digital asset platform 104.

In method 350, in blocks 301 to 308, like operations of like numbered blocks discussed with reference to method 300 (FIG. 3A) may be performed.

In response to determining that the user interacted with the advertisement, in block 352, an amount of additional digital assets for the user that are associated with historical reengagement by the user may be determined. For example, based on historical engagement data for a user, the DSP may estimate a likely amount of digital assets that would incentivize the user to reengage (e.g., rewatch a video, return to a website, etc.) or further engage (e.g., watch a longer portion of a video, remain on a website, etc.).

In block 354, an indication of the amount of additional digital assets may be provided to the advertiser. For example, the DSP may provide an indication of such an estimated reengagement amount of digital assets to an advertiser after a user engages with the advertiser's initial advertisement. In this manner, the advertiser may identify a specific amount of digital assets for that user that may support reengagement.

The method 350 may proceed to block 301 where the advertiser may again be enabled to attach a digital asset offering to an advertisement via the DSP. For example, the advertiser may direct the DSP to offer the estimated reengagement amount of digital assets to the user for the reengagement. In this manner, the user may be incentivized to reengage with an advertisement of the advertiser.

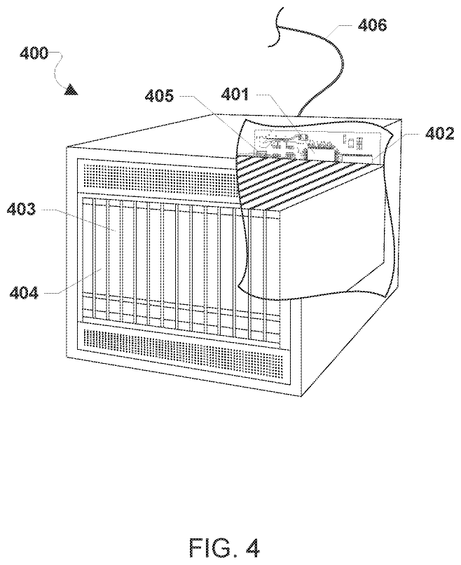

The various embodiment methods may also be performed partially or completely on a variety of computing devices, such as a server. Such embodiments may be implemented on any of a variety of commercially available server devices, such as the server 400 illustrated in FIG. 4. With reference to FIGS. 1-4, such a server 400 typically includes a processor 401 coupled to internal memory 402 (e.g., volatile memory) and a large capacity nonvolatile memory 403, such as a disk drive. The server 400 may also include a floppy disc drive, compact disc (CD) or DVD disc drive 404 coupled to the processor 401. The server 400 may also include network access ports 405 coupled to the processor 401 for establishing data connections with a network 406, such as a local area network coupled to other broadcast system computers and servers. The processor 401 may be any programmable microprocessor, microcomputer or multiple processor chip or chips that may be configured by software instructions (applications) to perform a variety of functions, including the functions of the various embodiments described above. Typically, software applications may be stored in the memory 402, 403 before they are accessed and loaded into the processor 401. The processor 401 may include internal memory sufficient to store the application software instructions.

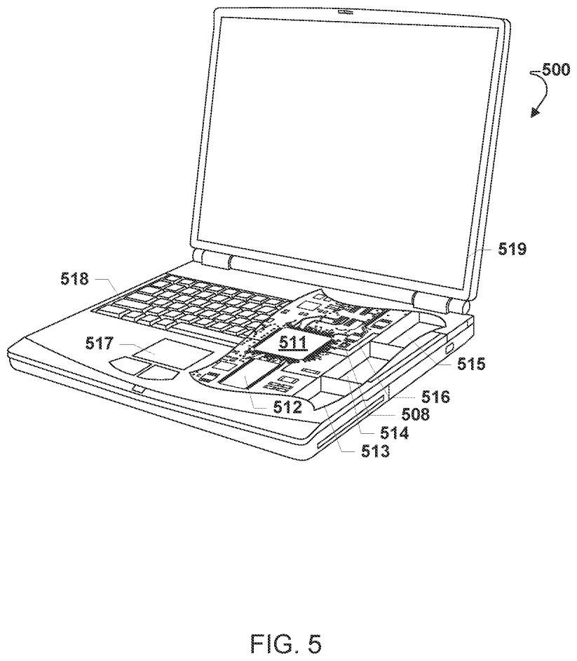

The various embodiments described above may also be implemented within a variety of computing devices, such as a laptop computer 500 illustrated in FIG. 5. With reference to FIGS. 1-5, many laptop computers include a touchpad 517 with touch surface that serves as the computer's pointing device, and thus may receive drag, scroll, and flick gestures similar to those implemented on mobile computing devices equipped with a touch screen display and described above. A laptop computer 500 will typically include a processor 511 coupled to volatile memory 512 and a large capacity nonvolatile memory, such as a disk drive 513 of Flash memory. Additionally, the laptop computer 500 may have one or more antennas 508 for sending and receiving electromagnetic radiation that may be connected to a wireless data link and/or cellular telephone transceiver 516 coupled to the processor 511. The laptop computer 500 may also include a floppy disc drive 514 and a compact disc (CD) drive 515 coupled to the processor 511. In a notebook configuration, the computer housing includes the touchpad 517, the keyboard 518, and the display 519 all coupled to the processor 511. Other configurations of the mobile computing device may include a computer mouse or trackball coupled to the processor (e.g., via a USB input) as are well known, which may also be used in conjunction with the various embodiments.

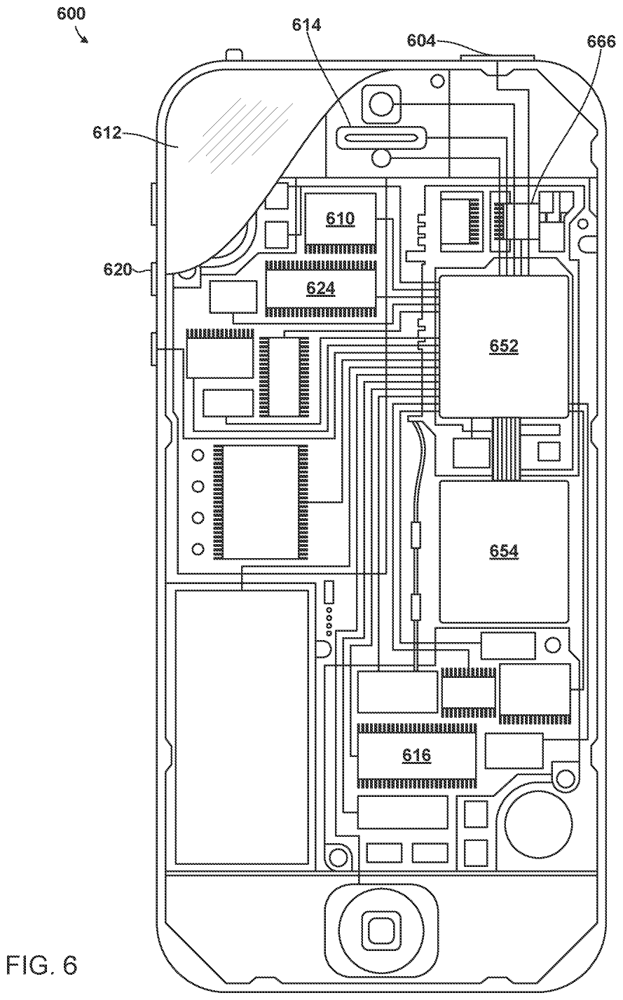

FIG. 6 is a component block diagram of a computing device, such as a computing device 600, suitable for use with various embodiments. With reference to FIGS. 1-6, various embodiments may be implemented on a variety of computing devices 600, an example of which is illustrated in FIG. 6 in the form of a smartphone. The computing device 600 may include a first system-on-chip (SOC) 652 (e.g., a SOC-CPU) coupled to a second SOC 654 (e.g., a 4G, 5G, etc., capable SOC). The first and second SOCs 652, 654 may be coupled to internal memory 624, 616, a display 612, and to a speaker 614. Additionally, the computing device 600 may include an antenna 604 for sending and receiving electromagnetic radiation that may be connected to a wireless transceiver 666 coupled to one or more processors in the first and/or second SOCs 652, 654. The computing device 600 may also include menu selection buttons or rocker switches 620 for receiving user inputs.

The computing device 600 also includes a sound encoding/decoding (CODEC) circuit 610, which digitizes sound received from a microphone into data packets suitable for wireless transmission and decodes received sound data packets to generate analog signals that are provided to the speaker to generate sound. Also, one or more of the processors in the first and second SOCs 652, 654, wireless transceiver 666 and CODEC 610 may include a digital signal processor (DSP) circuit.

The processors of the computing devices discussed herein may be any programmable microprocessor, microcomputer or multiple processor chip or chips that can be configured by software instructions (applications) to perform a variety of functions, including the functions of the various embodiments described below. In some computing devices, multiple processors may be provided, such as one processor within an SOC 654 dedicated to wireless communication functions and one processor within an SOC 652 dedicated to running other applications. Software applications may be stored in the memory before they are accessed and loaded into the processor. The processors may include internal memory sufficient to store the application software instructions.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

As used in this application, the terms “component,” “module,” “system,” “engine,” “generator,” “unit,” “manager” and the like are used interchangeably herein and are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the embodiments disclosed herein may be implemented or performed with a general purpose processor, a GPU, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a multiprocessor, but, in the alternative, the processor may be any conventional processor, controller, microcontroller, or state machine. A processor may also be implemented as a combination of computing devices, e.g., a combination of a DSP and a multiprocessor, a plurality of multiprocessors, one or more multiprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the claims are not intended to be limited to the embodiments shown herein but are to be accorded the widest scope consistent with the language of the claims and the principles and novel features disclosed herein.

What is claimed is:

1. A method for rewarding end users for engaging with and/or supplying data to advertisers, comprising:
enabling an advertiser to attach a digital asset offering to an advertisement via a demand-side platform (DSP);
offering the advertisement to a user including an indication of the offered digital asset;
determining that the user interacted with the advertisement; and
in response to determining that the user interacted with the advertisement:
providing the offered digital asset to the user; and
providing user data to the advertiser, wherein the user data includes a verifiable attribute associated with one or both of the user and the provided offered digital asset.

2. The method of claim 1, further comprising:
providing feedback to the advertiser via the DSP regarding the providing of the offered digital asset to the user.

3. The method of claim 2, wherein the digital asset is a cryptocurrency, a non-fungible token, a semi-fungible token, or a fungible token.

4. The method of claim 1, wherein the user data is data the user provided explicit permission to collect.

5. The method of claim 4, wherein the user data is zero-party data.

6. The method of claim 1, wherein the user interaction is one or more of a click, a video playout, and a data input.

7. The method of claim 1, further comprising:
determining an amount of additional digital assets for the user that are associated with historical reengagement by the user in response to determining that the user interacted with the advertisement; and
providing an indication of the amount of additional digital assets to the advertiser.

8. A demand-side platform (DSP), comprising:
a processor configured to perform operations comprising:
enabling an advertiser to attach a digital asset offering to an advertisement via a demand-side platform (DSP);
offering the advertisement to a user including an indication of the offered digital asset;
determining that the user interacted with the advertisement; and
in response to determining that the user interacted with the advertisement:
providing the offered digital asset to the user; and
providing user data to the advertiser, wherein the user data includes a verifiable attribute associated with one or both of the user and the provided offered digital asset.

9. The DSP of claim 8, wherein the processor is configured to perform operations further comprising:
providing feedback to the advertiser via the DSP regarding the providing of the offered digital asset to the user.

10. The DSP of claim 9, wherein the digital asset is a cryptocurrency, a non-fungible token, a semi-fungible token, or a fungible token.

11. The DSP of claim 8, wherein the user data is data the user provided explicit permission to collect.

12. The DSP of claim 11, wherein the user data is zero-party data.

13. The DSP of claim 8, wherein the user interaction is one or more of a click, a video playout, and a data input.

14. The DSP of claim 8, wherein the processor is configured to perform operations further comprising:
determining an amount of additional digital assets for the user that are associated with historical reengagement by the user in response to determining that the user interacted with the advertisement; and
providing an indication of the amount of additional digital assets to the advertiser.
